(19) United States
(12) Patent Application Publication
(10) Pub. No.: US 2026/0340248 A1
(43) Pub. Date: Oct. 29, 2026

(54) THREE-DIMENSIONAL INTEGRATED CIRCUIT INCLUDING PLURALITY OF SEMICONDUCTOR DIES, AND METHOD THEREOF INCLUDING STATIC TIMING ANALYSIS

(71) Applicant: SAMSUNG ELECTRONICS CO., LTD., Suwon-si (KR)

(72) Inventors: Changju LEE, Suwon-si (KR); Jiyoon SHIN, Suwon-si (KR); Bongil PARK, Suwon-si (KR)

(73) Assignee: SAMSUNG ELECTRONICS CO., LTD., Suwon-si (KR)

(21) Appl. No.: 19/653,988

(22) Filed: Apr. 21, 2026

(30) Foreign Application Priority Data
Apr. 24, 2025 (KR) 10-2025-0054110
Apr. 24, 2025 (KR) 10-2025-0054112
Sep. 15, 2025 (KR) 10-2025-0132053

(51) Int. Cl. G06F 30/3315

(52) U.S. Cl. CPC G06F 30/3315

(57) ABSTRACT

A method performed by at least one processor may include: designing a three-dimensional integrated circuit, the three-dimensional integrated circuit including: a first semiconductor die including a first logic circuit and a first interface circuit; a second semiconductor die including a second logic circuit and a second interface circuit; and a plurality of interconnects configured to connect the first interface circuit to the second interface circuit; and performing static timing analysis (STA) individually for a first STA target group, a second STA target group, and a third STA target group of the three-dimensional integrated circuit.

### CROSS-REFERENCE TO RELATED APPLICATIONS

This application is based on and claims priority under 35 U.S.C. §119 to Korean Patent Application Nos. 10-2025-0054112, filed on Apr. 24, 2025, 10-2025-0054110, filed on Apr. 24, 2025, and 10-2025-0132053, filed on Sep. 15, 2025, in the Korean Intellectual Property Office, the disclosures of which are incorporated by reference herein in their entireties.

### BACKGROUND

### 1. Field

Some embodiments of the present disclosure relate to a three-dimensional integrated circuit, and more particularly, to a three-dimensional integrated circuit including a plurality of semiconductor dies stacked on one another.

### 2. Description of Related Art

A three-dimensional integrated circuit may include a plurality of semiconductor dies (or integrated circuits) stacked on one another. The semiconductor dies included in the three-dimensional integrated circuit may be electrically connected to each other to perform communication. Specifically, a first semiconductor die and a second semiconductor die may perform communication as a first flip-flop of the first semiconductor die transmits a signal to a second flip-flop of the second semiconductor die or a third flip-flop of the first semiconductor die receives a signal from a fourth flip-flop of the second semiconductor die.

In designing the three-dimensional integrated circuit, processes and operating voltages of each of the plurality of semiconductor dies should be set in various combinations to perform timing sign-off, such as static timing analysis. Since a single semiconductor die may include a very large number of active devices and a plurality of semiconductor dies are manufactured separately, the turnaround time for static timing analysis in designing the three-dimensional integrated circuit may increase exponentially.

In addition, in the three-dimensional integrated circuit, the process defect rate for connecting semiconductor dies may be considerably higher than the process defect rate for metal routing within a single silicon element, and thus the defect rate of interconnects between the semiconductor dies may be high. To address this, the three-dimensional integrated circuit may include a repair circuit for replacing a defective interconnect with a normal interconnect.

Since the defective interconnect can cause overcurrent or leakage current in the three-dimensional integrated circuit, there is a need for a circuit structure for isolating the defective interconnect.

### SUMMARY

According to some embodiments of the present disclosure, a three-dimensional integrated circuit that effectively reduces the turnaround time for static timing analysis for the three-dimensional integrated circuit may be provided by designing interface circuits of semiconductor dies in the three-dimensional integrated circuit to have symmetrical and simple structures.

According to some embodiments of the present disclosure, a three-dimensional integrated circuit including a circuit configured to effectively isolate a defective interconnect therein may be provided.

According to some embodiments of the present disclosure, a method performed by at least one processor may include: designing a three-dimensional integrated circuit, the three-dimensional integrated circuit including: a first semiconductor die including a first logic circuit and a first interface circuit; a second semiconductor die including a second logic circuit and a second interface circuit; and a plurality of interconnects configured to connect the first interface circuit to the second interface circuit; and performing static timing analysis (STA) individually for a first STA target group, a second STA target group, and a third STA target group of the three-dimensional integrated circuit, wherein the first logic circuit and a first portion of the first interface circuit are included in the first STA target group, wherein the second logic circuit and a first portion of the second interface circuit are included in the second STA target group, and wherein a second portion of the first interface circuit, the plurality of interconnects, and a second portion of the second interface circuit are included in the third STA target group.

According to some embodiments of the present disclosure, a three-dimensional integrated circuit may include: a first semiconductor die comprising a first logic circuit configured to perform a first data processing operation and a first interface circuit comprising a first unit circuit; a second semiconductor die comprising a second logic circuit configured to perform a second data processing operation and a second interface circuit comprising a second unit circuit; and a plurality of interconnects configured to connect the first unit circuit to the second unit circuit, wherein the first unit circuit comprises a plurality of first flip-flops and a plurality of transmission buffers configured to transmit a plurality of first data signals and a first clock signal through the plurality of interconnects, wherein the second unit circuit comprises a plurality of second flip-flops and a plurality of reception buffers configured to receive the plurality of first data signals and the first clock signal through the plurality of interconnects, and wherein components of the first unit circuit and components of the second unit circuit are arranged symmetrically.

According to some embodiments of the present disclosure, a method performed by at least one processor may include: designing a three-dimensional integrated circuit, the three-dimensional integrated circuit including: a first semiconductor die including a first interface circuit including a plurality of first unit circuits; a second semiconductor die including a second interface circuit including a plurality of second unit circuits; and a plurality of interconnects configured to connect the first interface circuit to the second interface circuit; and performing static timing analysis (STA), based on process conditions of the first semiconductor die and the second semiconductor die, for at least one STA target group of the three-dimensional integrated circuit, wherein each of the plurality of first unit circuits is configured to output a clock signal and a plurality of data signals through some of the plurality of interconnects, wherein each of the plurality of second unit circuits is configured to receive the clock signal and the plurality of data signals through some of the plurality of interconnects, and wherein the plurality of first unit circuits, the plurality of second unit circuits, and the plurality of interconnects are included in the at least one STA target group.

### BRIEF DESCRIPTION OF DRAWINGS

Embodiments will be more clearly understood from the following detailed description taken in conjunction with the accompanying drawings in which:

FIG. 1 is a block diagram of a three-dimensional integrated circuit according to an embodiment;

FIGS. 2A, 2B, and 2C are diagrams of interconnects according to an embodiment;

FIG. 3 is a flowchart of a design method of a three-dimensional integrated circuit according to an embodiment;

FIG. 4 is a flowchart of a specific embodiment of an operation in FIG. 3;

FIG. 5 is a detailed block diagram of a three-dimensional integrated circuit according to an embodiment;

FIG. 6 is a detailed block diagram of a three-dimensional integrated circuit according to an embodiment;

FIG. 7 is a detailed block diagram of a three-dimensional integrated circuit according to an embodiment;

FIG. 8 is a detailed block diagram of a three-dimensional integrated circuit according to an embodiment;

FIG. 9 is a detailed block diagram of a three-dimensional integrated circuit according to an embodiment;

FIG. 10 is a detailed block diagram of a three-dimensional integrated circuit according to an embodiment;

FIGS. 11A and 11B are diagrams illustrating an implementation of driving circuits according to an embodiment;

FIGS. 12A and 12B are diagrams illustrating an implementation of the driving circuits according to an embodiment;

FIG. 13 is a detailed block diagram of a three-dimensional integrated circuit according to an embodiment;

FIG. 14 is a detailed block diagram of a three-dimensional integrated circuit according to an embodiment;

FIG. 15 is a flowchart of a method of obtaining defect information regarding interconnects, according to an embodiment;

FIG. 16 is a flowchart of an operating method of the three-dimensional integrated circuit according to an embodiment; and

FIG. 17 is a structural diagram of an example of an electronic system including high-bandwidth memories (HBMs) according to an embodiment.

### DETAILED DESCRIPTION

Hereinafter, non-limiting example embodiments of the present disclosure are described in detail with reference to the accompanying drawings.

It will be understood that when an element or layer is referred to as being “on,” “connected to,” or “coupled to” another element or layer, it can be directly on, connected to, or coupled to the other element or layer or intervening elements or layers may be present. In contrast, when an element or layer is referred to as being “directly on,” “directly connected to,” or “directly coupled to” another element or layer, there are no intervening elements or layers present.

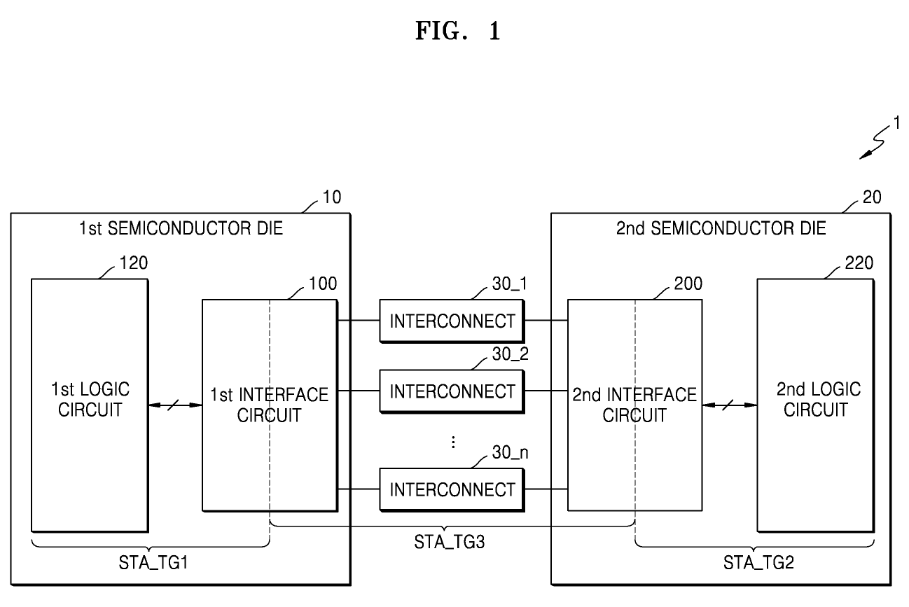

FIG. 1 is a block diagram of a three-dimensional integrated circuit 1 according to an embodiment. Hereinafter, embodiments are described by focusing on the three-dimensional integrated circuit 1 including a first semiconductor die 10 and a second semiconductor die 20, but this is for convenience of explanation. The three-dimensional integrated circuit 1 may include more than two semiconductor dies.

Referring to FIG. 1, the three-dimensional integrated circuit 1 may include the first semiconductor die 10, the second semiconductor die 20, and a plurality of interconnects 30_1 to 30_n (e.g., interconnects 30_1, 30_2, …, 30_n).

Each of the first semiconductor die 10 and the second semiconductor die 20 may include an integrated circuit that performs a certain function and may be referred to as a logic die, a memory die, and an analog die, depending on its function. The first semiconductor die 10 and the second semiconductor die 20 may perform the same or different functions from each other. The first semiconductor die 10 and the second semiconductor die 20 may be formed on a silicon substrate, a silicon-on-insulator substrate, or a compound semiconductor substrate. The first semiconductor die 10 and the second semiconductor die 20 may include a plurality of active devices and a plurality of passive devices, wherein each device may be wired through a metal layer. Depending on a process scheme for the three-dimensional integrated circuit 1, the process for forming the first semiconductor die 10 may be the same as or different from the process for forming the second semiconductor die 20. When designing the three-dimensional integrated circuit 1, it is beneficial to consider that the process for forming the first semiconductor die 10 may differ from the process for forming the second semiconductor die 20. This may increase the turnaround time for static timing analysis in the design process and thus degrade the efficiency of resources used for the design in a comparative embodiment. The characteristic structure of the three-dimensional integrated circuit 1 according to an embodiment may effectively reduce the turnaround time for static timing analysis.

The plurality of interconnects 30_1 to 30_n, which may be structures for transmitting electrical signals between the first semiconductor die 10 and the second semiconductor die 20, may be implemented as through-silicon vias (TSVs), micro bumps, or hybrid bonding.

In addition, the first semiconductor die 10 and the second semiconductor die 20 may be vertically stacked on each other. The first semiconductor die 10 and the second semiconductor die 20 may be stacked using die-to-die stacking, die-to-wafer stacking, or wafer-to-wafer stacking methods.

In an embodiment, the first semiconductor die 10 may include a first interface circuit 100 and a first logic circuit 120. The second semiconductor die 20 may include a second interface circuit 200 and a second logic circuit 220.

The first logic circuit 120, which may perform data processing operations, such as arithmetic, control, or decision operations, corresponding to certain functions supported by the first semiconductor die 10, may include at least one from among an arithmetic logic circuit, a control circuit, a register, a multiplexer, a sequential logic circuit, and a combinational logic circuit. The second logic circuit 220, which may perform data processing operations such as arithmetic, control, or decision operations corresponding to certain functions supported by the second semiconductor die 20, may include at least one from among an arithmetic logic circuit, a control circuit, a register, a multiplexer, a sequential logic circuit, and a combinational logic circuit. In some embodiments, the first logic circuit 120 and the second logic circuit 220 may be variously defined as all or part of regions of the first semiconductor die 10 and the second semiconductor die 20 other than the first interface circuit 100 and the second interface circuit 200, respectively.

In an embodiment, as circuits responsible for transmitting and receiving various signals between the first semiconductor die 10 and the second semiconductor die 20, the first interface circuit 100 and the second interface circuit 200 may be implemented to have symmetrical structures. In an embodiment, the first interface circuit 100 and the second interface circuit 200 may be implemented to have simple structures by including a plurality of flip-flops and a plurality of buffers. In addition, in an embodiment, the first interface circuit 100 may be arranged as close as possible to the boundary of the first semiconductor die 10 adjacent to the plurality of interconnects 30_1 to 30_n, and the second interface circuit 200 may be arranged as close as possible to the boundary of the second semiconductor die 20 adjacent to the plurality of interconnects 30_1 to 30_n.

In an embodiment, the plurality of flip-flops and the plurality of buffers of the first interface circuit 100 and the second interface circuit 200 may be divided into a plurality of unit circuits. In this specification, a unit circuit may be defined as a circuit for transmitting or receiving one clock signal and a certain number of data signals.

Hereinafter, static timing analysis for the three-dimensional integrated circuit 1 at the design stage is described. In this specification, the static timing analysis may include a technique for analyzing timing by statically calculating the delay time for each path of a target circuit to verify that all signals are properly transmitted within a certain clock cycle in the target circuit. In this specification, the static timing analysis may also be referred to as STA.

In an embodiment, the first logic circuit 120 and a first portion of the first interface circuit 100 may be included in a first STA target group STA_TG1, the second logic circuit 220 and a first portion of the second interface circuit 200 may be included in a second STA target group STA_TG2, and a second portion of the first interface circuit 100, the plurality of interconnects 30_1 to 30_n, and a second portion of the second interface circuit 200 may be included in a third STA target group STA_TG3.

In an embodiment, static timing analysis for the first STA target group STA_TG1, static timing analysis for the second STA target group STA_TG2, and static timing analysis for the third STA target group STA_TG3 may be performed individually.

In an embodiment, after static timing analysis for the first STA target group STA_TG1 and the second target group STA_TG2 is completed, static timing analysis for the third STA target group STA_TG3 may be performed. However, this is only an example and embodiments of the present disclosure are not limited thereto. The static timing analysis may be performed sequentially for the first to third STA target groups STA_TG1, STA_TG2, and STA_TG3 in various orders.

In an embodiment, static timing analysis for the first STA target group STA_TG1 may be performed based on a process condition of the first semiconductor die 10. In this specification, the process condition may be defined based on a change in characteristics of an active device caused by a process variation during a manufacturing process. For example, the process condition may be defined as a typical-typical (TT) corner when it is assumed that the active device is manufactured to have a reference speed through a normal process, as a slow-slow (SS) corner when it is assumed that the active device is manufactured to be slower due to the process variation, and as a fast-fast (FF) corner when it is assumed that the active device is manufactured to be faster due to the process variation. In some embodiments, the process condition may be defined as a greater number of corners than the corners described above. Since the first STA target group STA_TG1 belongs to the first semiconductor die 10, the first STA target group STA_TG1 may be expected to have the same process variation. Thus, static timing analysis for the first STA target group STA_TG1 may be performed considering only the process condition of the first semiconductor die 10. Accordingly, the turnaround time for static timing analysis may be short.

In an embodiment, static timing analysis for the second STA target group STA_TG2 may be performed based on the process condition of the second semiconductor die 20. That is, since the second STA target group STA_TG2 belongs to the second semiconductor die 20, the second STA target group STA_TG2 may be expected to have the same process variation. Thus, static timing analysis for the second STA target group STA_TG2 may be performed considering only the process condition of the second semiconductor die 20. Accordingly, the turnaround time for static timing analysis may also be short.

In addition, in an embodiment, static timing analysis for the third STA target group STA_TG3 may be performed based on the process conditions of the first semiconductor die 10 and the second semiconductor die 20. That is, since a portion of the third STA target group STA_TG3 belongs to the first semiconductor die 10 and another portion of the third STA target group STA_TG3 belongs to the second semiconductor die 20, components of the third STA target group STA_TG3 may be expected to have different process variations from one another. Thus, static timing analysis for the third STA target group STA_TG3 may be performed considering all the process conditions of the first semiconductor die 10 and the second semiconductor die 20. However, since the first interface circuit 100 and the second interface circuit 200 have symmetrical and simple structures, the turnaround time may not be long even when considering all the process conditions of the first semiconductor die 10 and the second semiconductor die 20.

As a result, in designing the three-dimensional integrated circuit 1, the overall turnaround time may be effectively reduced. A voltage condition and a temperature condition may be further considered in static timing analysis for the first to third STA target groups STA_TG1, STA_TG2, and STA_TG3.

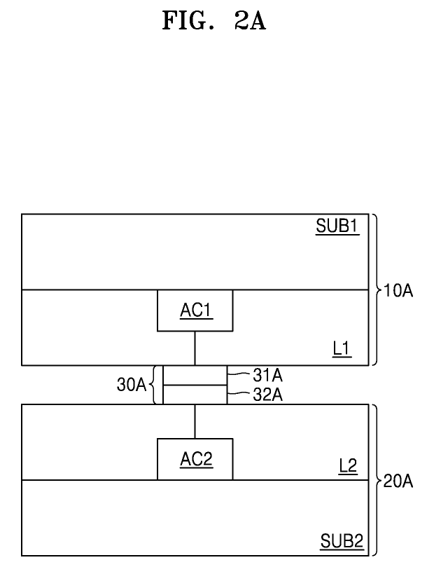

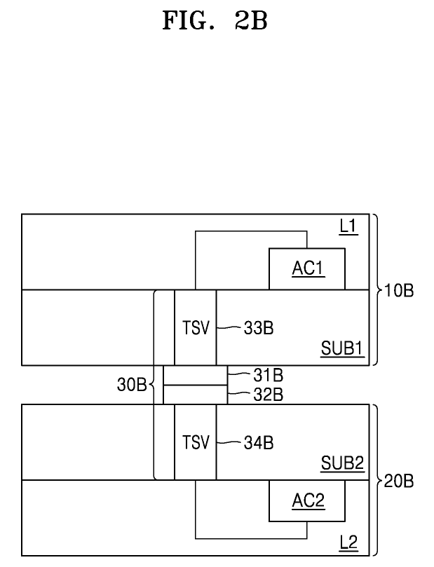

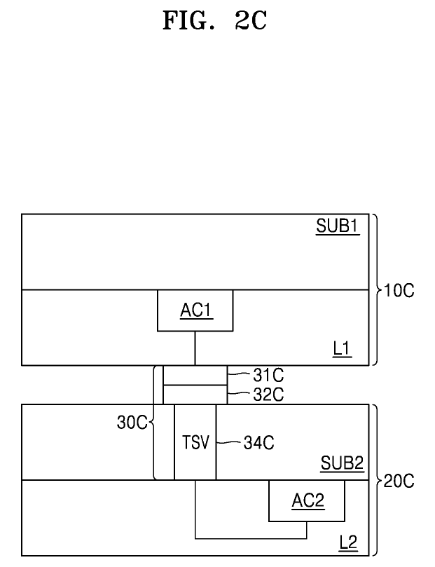

FIGS. 2A-2C are diagrams of interconnects 30A, 30B, and 30C according to an embodiment.

Referring to FIG. 2A, a first semiconductor die 10A may include a substrate SUB1 and a layer L1 formed by back end of line (BEOL), and the layer L1 may include an active device AC1 formed by front end of line (FEOL). A second semiconductor die 20A may include a substrate SUB2 and a layer L2 formed by BEOL, and the layer L2 may include an active device AC2 formed by FEOL.

The first semiconductor die 10A and the second semiconductor die 20A may be stacked in a face-to-face (F2F) manner. Specifically, a bonding pad 31A connected to the active device AC1 may be formed on the layer L1 of the first semiconductor die 10A, and a bonding pad 32A connected to the active device AC2 may be formed on the layer L2 of the second semiconductor die 20A, wherein the bonding pad 31A may be bonded to the bonding pad 32A. Accordingly, an interconnect 30A may include the bonding pads 31A and 32A.

Referring further to FIG. 2B, a first semiconductor die 10B may include a substrate SUB1 having a TSV 33B formed thereon, and a layer L1 having an active device AC1 formed thereon and connected to the TSV 33B. A second semiconductor die 20B may include a substrate SUB2 having a TSV 34B formed thereon, and a layer L2 having an active device AC2 formed thereon and connected to the TSV 34B.

Specifically, the first semiconductor die 10B and the second semiconductor die 20B may be stacked in a back-to-back (B2B) manner. Specifically, a bonding pad 31B connected to the TSV 33B may be formed on the substrate SUB1 of the first semiconductor die 10B, and a bonding pad 32B connected to the TSV 34B may be formed on the substrate SUB2 of the second semiconductor die 20B, wherein the bonding pad 31B may be bonded to the bonding pad 32B. Accordingly, an interconnect 30B may include the bonding pads 31B and 32B and the TSVs 33B and 34B.

Referring further to FIG. 2C, a first semiconductor die 10C may include a substrate SUB1 and a layer L1 having an active device AC1 formed thereon. A second semiconductor die 20C may include a substrate SUB2 having a TSV 34C formed thereon and a layer L2 having an active device AC2 formed thereon and connected to the TSV 34C.

Specifically, the first semiconductor die 10C and the second semiconductor die 20C may be stacked in a face-to-back (F2B) manner. Specifically, a bonding pad 31C connected to the active device AC1 may be formed on the layer L1 of the first semiconductor die 10C, and a bonding pad 32C connected to the TSV 34C may be formed on the substrate SUB2 of the second semiconductor die 20C, wherein the bonding pad 31C may be bonded to the bonding pad 32C. Accordingly, an interconnect 30C may include the bonding pads 31C and 32C and the TSV 34C.

However, implementations of the interconnects 30A, 30B, and 30C of FIGS. 2A-2C are only examples and embodiments of the present disclosure are not limited thereto. The interconnects may be implemented in various other forms within the spirit and scope of the present disclosure.

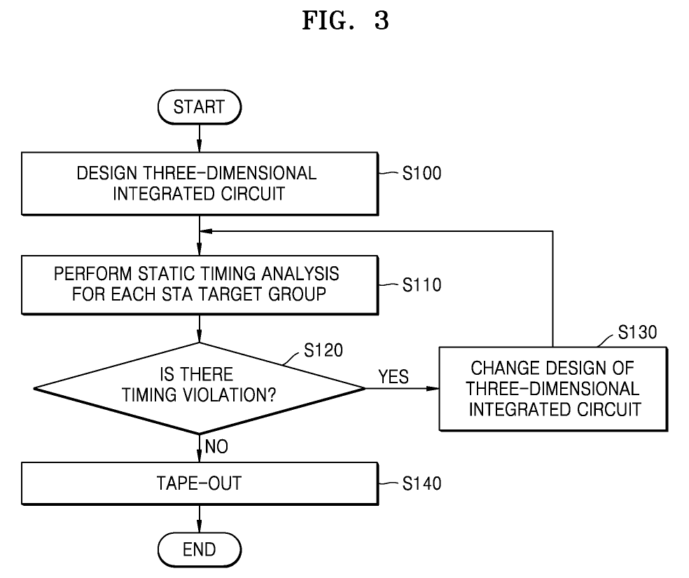

FIG. 3 is a flowchart of a design method of a three-dimensional integrated circuit according to an embodiment.

Referring to FIG. 3, in an operation S100, at least one processor may design the three-dimensional integrated circuit based on a circuit design tool. For example, the circuit design tool may correspond to an electronic design automation (EDA) tool.

In an operation S110, the at least one processor may perform static timing analysis for each STA target group. For example, the at least one processor may individually perform static timing analysis on the first to third STA target groups STA_TG1, STA_TG2, and STA_TG3 in FIG. 1. For example, after the specification for the three-dimensional integrated circuit is defined in the operation S100 and conversion to a gate-level circuit is completed by logically synthesizing the designed register transfer level (RTL), the operation S110 may be performed as pre-layout STA. In another example, after place and routing for the three-dimensional integrated circuit is completed in the operation S100, the operation S110 may be performed as post-layout STA. In another example, the operation S110 may be performed as final STA immediately before tape-out.

In an operation S120, the at least one processor may determine whether there is a timing violation in a result of the static timing analysis that has been performed. For example, the timing violation may include at least one from among a setup time violation, a hold time violation, a clock skew violation, a pulse width violation, a min/max delay violation, and a recovery/removal violation.

When the result of operation S120 is “Yes,” an operation S130 may be subsequently performed so that the at least one processor changes the design of the three-dimensional integrated circuit.

When the result of operation S120 is “No,” the operation S140 may be subsequently performed so that the at least one processor performs tape-out to transmit the final design of the three-dimensional integrated circuit to a semiconductor foundry.

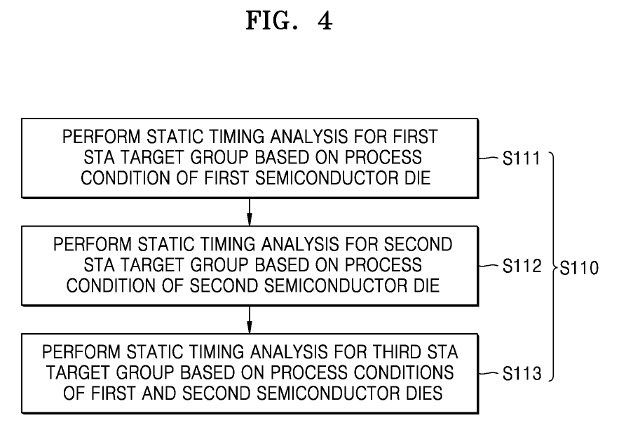

FIG. 4 is a flowchart of a specific embodiment of the operation S110 in FIG. 3. Hereinafter, FIG. 1 is also referred to for ease of understanding.

Referring to FIG. 4, the operation S110 may include operations S111 to S113.

In the operation S111, the at least one processor may perform static timing analysis for the first STA target group STA_TG1 based on the process condition of the first semiconductor die 10. Specifically, the at least one processor may perform static timing analysis by uniformly applying the varying process condition to a design circuit corresponding to the first logic circuit 120 and a first portion of the first interface circuit 100. For example, when there are x process conditions (where x is an integer of 1 or greater), static timing analysis in the operation S111 may be performed for x combinations.

In the operation S112, the at least one processor may perform static timing analysis for the second STA target group STA_TG2 based on the process condition of the second semiconductor die 20. Specifically, the at least one processor may perform static timing analysis by uniformly applying the varying process condition to a design circuit corresponding to the second logic circuit 220 and the first portion of the second interface circuit 200. For example, when there are x process conditions, static timing analysis in the operation S112 may be performed for x combinations.

In the operation S113, the at least one processor may perform static timing analysis for the third STA target group STA_TG3 based on the process conditions of the first semiconductor die 10 and the second semiconductor die 20. Specifically, the at least one processor may perform static timing analysis by uniformly or non-uniformly applying the varying process condition to a design circuit corresponding to the second portion of the first interface circuit 100, the plurality of interconnects 30_1 to 30_n, and the second portion of the second interface circuit 200. For example, when there are x process conditions, static timing analysis in the operation S113 may be performed for x² combinations.

The at least one processor may vary the voltage condition and the temperature condition along with the process condition and perform static timing analysis for the first to third STA target groups STA_TG1, STA_TG2, and STA_TG3.

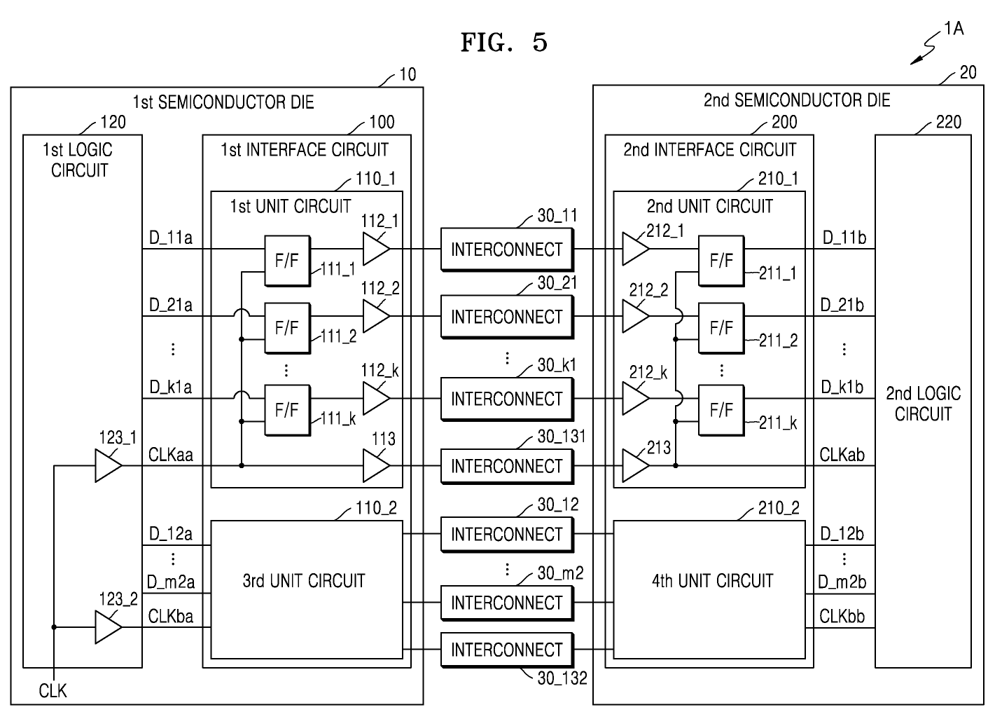

FIG. 5 is a detailed block diagram of a three-dimensional integrated circuit 1A according to an embodiment.

Referring to FIG. 5, the three-dimensional integrated circuit 1A may include the first semiconductor die 10, the second semiconductor die 20, first interconnects 30_11 to 30_k1 (e.g., first interconnects 30_11, 30_21, …, 30_k1) and 30_131, and second interconnects 30_12 to 30_m2 and 30_132.

The first semiconductor die 10 may include the first interface circuit 100 and the first logic circuit 120. The first interface circuit 100 may include a first unit circuit 110_1 and a third unit circuit 110_2.

The second semiconductor die 20 may include the second interface circuit 200 and the second logic circuit 220. The second interface circuit 200 may include a second unit circuit 210_1 and a fourth unit circuit 210_2.

For example, the first unit circuit 110_1 and the third unit circuit 110_2 may be referred to as unit transmission circuits, and the second unit circuit 210_1 and the fourth unit circuit 210_2 may be referred to as unit reception circuits. The first interface circuit 100 may further include unit reception circuits, and the second interface circuit 200 may further include unit transmission circuits. Specific embodiments thereof are described below.

In an embodiment, as the first unit circuit 110_1 may correspond to the second unit circuit 210_1, components of the first unit circuit 110_1 and components of the second unit circuit 210_1 may be arranged symmetrically with respect to each other.

In an embodiment, the first unit circuit 110_1 may transmit first data signals D_11a to D_k1a (e.g., first data signals D_11a, D_21a …, D_k1a) and a first clock signal CLKaa received from the first logic circuit 120 to the second unit circuit 210_1 through the first interconnects 30_11 to 30_k1 and 30_131. The first unit circuit 110_1 may include first flip-flops 111_1 to 111_k (e.g., first flip-flops 111_1, 111_2, …, 111_k) and first transmission buffers 112_1 to 112_k (e.g., first transmission buffers 112_1, 112_2, …, 112_k) and 113. In this specification, a transmission buffer may be defined as a buffer configured to enhance electrical characteristics of a signal to be transmitted. The first flip-flops 111_1 to 111_k may output the received first data signals D_11a to D_k1a synchronized with the first clock signal CLKaa to the first transmission buffers 112_1 to 112_k. The first clock signal CLKaa, which may be output by a first clock buffer 123_1 of the first logic circuit 120, may be based on a global clock signal CLK. The first transmission buffers 112_1 to 112_k may output the first data signals D_11a to D_k1a through the first interconnects 30_11 to 30_k1. In addition, the first transmission buffer 113 may output the received first clock signal CLKaa through the first interconnect 30_131.

In an embodiment, the second unit circuit 210_1 may transmit first data signals D_11b to D_k1b (e.g., first data signals D_11b, D_21b, …, D_k1b) and a first clock signal CLKab received through the first interconnects 30_11 to 30_k1 and 30_131 to the second logic circuit 220. The second unit circuit 210_1 may include second flip-flops 211_1 to 211_k (e.g., second flip-flops 211_1, 211_2, …, 211_k) and first reception buffers 212_1 to 212_k (e.g., first reception buffers 212_1, 212_2, …, 212_k) and 213. In this specification, a reception buffer may be defined as a buffer configured to enhance electrical characteristics of a received signal. The second flip-flops 211_1 to 211_k may output the first data signals D_11b to D_k1b synchronized with the first clock signal CLKab and received through the first interconnects 30_11 to 30_k1 to the second logic circuit 220. In addition, the first reception buffer 213 may output the first clock signal CLKab received through the first interconnect 30_131 to the second flip-flops 211_1 to 211_k and the second logic circuit 220.

In an embodiment, as the third unit circuit 110_2 may correspond to the fourth unit circuit 210_2, components of the third unit circuit 110_2 and components of the fourth unit circuit 210_2 may be arranged symmetrically with respect to each other.

In an embodiment, the third unit circuit 110_2 may transmit second data signals D_12a to D_m2a and a second clock signal CLKba received from the first logic circuit 120 to the fourth unit circuit 210_2 through the second interconnects 30_12 to 30_m2 and 30_132. For example, the third unit circuit 110_2 may include a number of flip-flops and transmission buffers that is the same as or different from a number of flip-flops and transmission buffers of the first unit circuit 110_1. The second clock signal CLKba, which may be output by a second clock buffer 123_2 of the first logic circuit 120, may be based on the global clock signal CLK.

In an embodiment, the fourth unit circuit 210_2 may transmit second data signals D_12b to D_m2b and a second clock signal CLKbb received through the second interconnects 30_12 to 30_m2 and 30_132 to the second logic circuit 220. For example, the fourth unit circuit 210_2 may include a number of flip-flops and reception buffers that is the same as or different from a number of flip-flops and reception buffers of the second unit circuit 210_1.

In an embodiment, the lengths of first data paths from the first logic circuit 120 to the first flip-flops 111_1 to 111_k in the first semiconductor die 10 may differ from the lengths of second data paths from the second flip-flops 211_1 to 211_k to the second logic circuit 220 in the second semiconductor die 20 by less than a threshold. The threshold may be determined based on an error range in an actual process. At the design stage for the three-dimensional integrated circuit 1A, the first data paths may be designed to be identical to the second data paths.

In an embodiment, the lengths of third data paths from the first transmission buffers 112_1 to 112_k and 113 in the first semiconductor die 10 to starting points of the first interconnects 30_11 to 30_k1 and 30_131 may differ from the lengths of fourth data paths from ending points of the first interconnects 30_11 to 30_k1 and 30_131 to the first reception buffers 212_1 to 212_k and 213 in the second semiconductor die 20 by less than a threshold. The threshold may be determined based on the error range in the actual process. At the design stage for the three-dimensional integrated circuit 1A, the third data paths may be designed to be identical to the fourth data paths.

Through the above design, the first unit circuit 110_1 and the second unit circuit 210_1 may have symmetrical structures.

In an embodiment, in the first unit circuit 110_1, the difference in lengths between first clock signal paths for supplying the first clock signal CLKaa to the first flip-flops 111_1 to 111_k may be less than the threshold. The threshold may be determined based on the error range in the actual process. At the design stage for the three-dimensional integrated circuit 1A, the first clock signal paths may be designed to have the same length as each other. As a result, clock to data skew within the first unit circuit 110_1 may be minimized.

In addition, in an embodiment, the difference in lengths between second clock signal paths for supplying the first clock signal CLKab to the second flip-flops 211_1 to 211_k in the second unit circuit 210_1 may be less than the threshold. The threshold may be determined based on the error range in the actual process. At the design stage for the three-dimensional integrated circuit 1A, the second clock signal paths may be designed to have the same length as each other. As a result, clock to data skew within the second unit circuit 210_1 may be minimized.

In an embodiment, the first STA target group STA_TG1 described with reference to FIG. 1 may include the first flip-flops 111_1 to 111_k of the first unit circuit 110_1, the second STA target group STA_TG2 may include the second flip-flops 211_1 to 211_k of the second unit circuit 210_1, and the third STA target group STA_TG3 may include the first flip-flops 111_1 to 111_k, the first transmission buffers 112_1 to 112_k and 113, the first interconnects 30_11 to 30_k1 and 30_131, the first reception buffers 212_1 to 212_k and 213, and the second flip-flops 211_1 to 211_k.

In some embodiments, the first STA target group STA_TG1 described with reference to FIG. 1 may include portions (e.g., input portions) of the first flip-flops 111_1 to 111_k of the first unit circuit 110_1, the second STA target group STA_TG2 may include portions (e.g., output portions) of the second flip-flops 211_1 to 211_k of the second unit circuit 210_1, and the third STA target group STA_TG3 may include the other portions (e.g., output portions) of the first flip-flops 111_1 to 111_k, the first transmission buffers 112_1 to 112_k and 113, the first interconnects 30_11 to 30_k1 and 30_131, the first reception buffers 212_1 to 212_k and 213, and the other portions (e.g., input portions) of the second flip-flops 211_1 to 211_k.

The aforementioned design methods may also be applied to the third unit circuit 110_2 and the fourth unit circuit 210_2.

The first to fourth unit circuits 110_1, 110_2, 210_1, and 210_2 according to an embodiment may be implemented to have simple structures. For example, as the first transmission buffer 112_1 is arranged between the first flip-flop 111_1 and the first interconnect 30_11, the first flip-flop 111_1 and the first transmission buffer 112_1 may form a signal path for the first data signal D_11a in the first unit circuit 110_1.

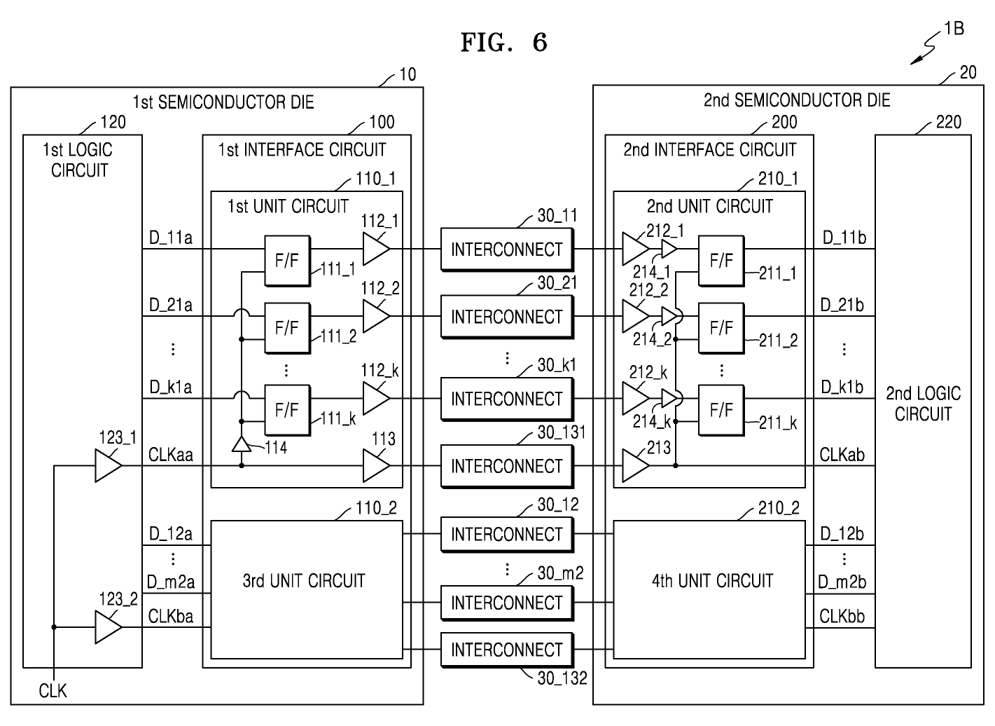

FIG. 6 is a detailed block diagram of a three-dimensional integrated circuit 1B according to an embodiment. Hereinafter, for convenience of explanation, a description that is substantially the same as a description given with reference to FIG. 5 may be omitted.

Referring to FIG. 6, the three-dimensional integrated circuit 1B may include the first semiconductor die 10, the second semiconductor die 20, the first interconnects 30_11 to 30_k1 and 30_131, and the second interconnects 30_12 to 30_m2 and 30_132.

For example, when the transmission speed of a data signal is greater than a transmission speed of a clock signal due to variations in the first interconnects 30_11 to 30_k1 and 30_131 and the second interconnects 30_12 to 30_m2 and 30_132, the hold time violation may occur. Thus, additional components for compensating therefor may be provided.

In an embodiment, the first unit circuit 110_1 may further include a first delay buffer 114 for delaying the first clock signal CLKaa provided to the first flip-flops 111_1 to 111_k by a certain time. In this specification, a delay buffer may be defined as a buffer configured to intentionally add a certain delay to meet a certain timing.

In an embodiment, the second unit circuit 210_1 may further include second delay buffers 214_1 to 214_k (e.g., second delay buffers 214_1, 214_2, …, 214_k) for delaying the first data signals D_11b to D_k1b provided to the second flip-flops 211_1 to 211_k by a certain time.

However, an embodiment of FIG. 6 is only an example, and embodiments of the present disclosure are not limited thereto. The delay buffers may be variously arranged within the unit circuit to prevent the timing violation.

As another example, when the transmission speed of the clock signal is greater than the transmission speed of the data signal due to variations in the first interconnects 30_11 to 30_k1 and 30_131 and the second interconnects 30_12 to 30_m2 and 30_132, additional components for compensating therefor may be arranged differently from the aforementioned embodiment.

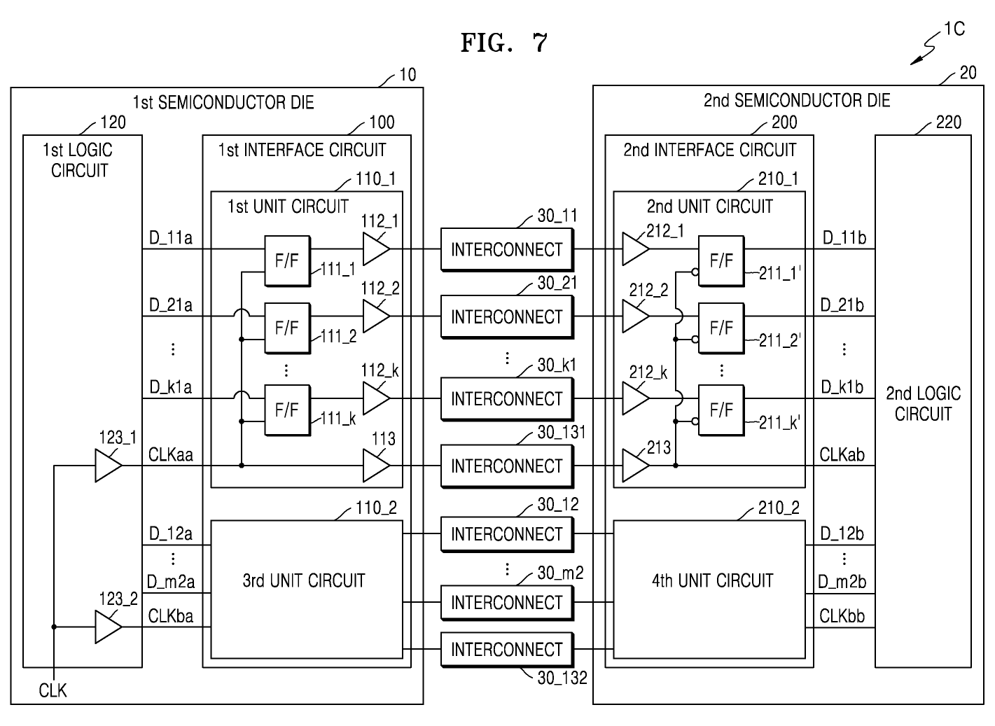

FIG. 7 is a detailed block diagram of a three-dimensional integrated circuit 1C according to an embodiment. Hereinafter, for convenience of explanation, a description that is substantially the same as a description given with reference to FIG. 5 may be omitted.

Referring to FIG. 7, the three-dimensional integrated circuit 1C may include the first semiconductor die 10, the second semiconductor die 20, the first interconnects 30_11 to 30_k1 and 30_131, and the second interconnects 30_12 to 30_m2 and 30_132.

In an embodiment, a first edge (e.g., a rising edge) of the first clock signal CLKaa for operating the first flip-flops 111_1 to 111_k may be different from a second edge (e.g., a falling edge) of the first clock signal CLKab for operating second flip-flops 211_1’ to 211_k’.

Accordingly, in static timing analysis for the three-dimensional integrated circuit 1C, conditions for hold time violation may be greatly alleviated, and signal propagation delay through the first interconnects 30_11 to 30_k1 and 30_131 and the second interconnects 30_12 to 30_m2 and 30_132 may be reduced.

However, the embodiment of the three-dimensional integrated circuit 1C of FIG. 7 is only an example, and embodiments of the present disclosure are not limited thereto.

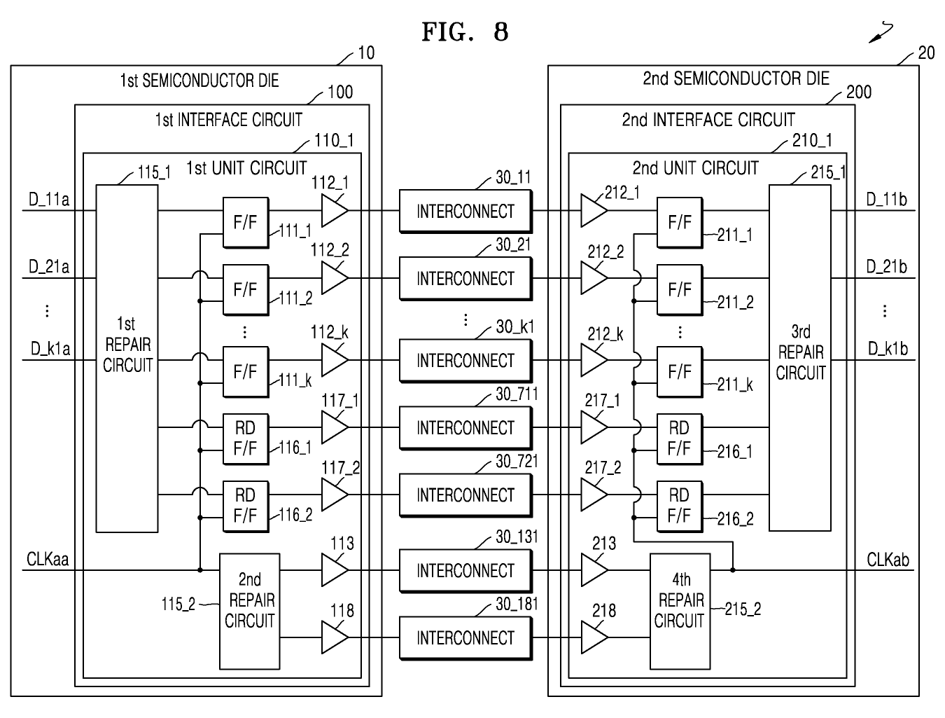

FIG. 8 is a detailed block diagram of a three-dimensional integrated circuit 1D according to an embodiment. Hereinafter, for convenience of explanation, a description that is substantially the same as a description given with reference to FIG. 5 may be omitted.

Referring to FIG. 8, the three-dimensional integrated circuit 1D may include the first semiconductor die 10, the second semiconductor die 20, the first interconnects 30_11 to 30_k1 and 30_131, and redundancy interconnects 30_711, 30_721, and 30_181.

In an embodiment, the first interface circuit 100 of the first semiconductor die 10 may include the first unit circuit 110_1, and the first unit circuit 110_1 may include the first flip-flops 111_1 to 111_k, the first transmission buffers 112_1 to 112_k and 113, a first repair circuit 115_1, a second repair circuit 115_2, first redundancy flip-flops 116_1 and 116_2, and first redundancy transmission buffers 117_1, 117_2, and 118. For example, the first redundancy flip-flops 116_1 and 116_2 may replace some of the first flip-flops 111_1 to 111_k, and the first redundancy transmission buffers 117_1, 117_2, and 118 may replace some of the first transmission buffers 112_1 to 112_k and 113.

In an embodiment, the first repair circuit 115_1 may route the first data signals D_11a to D_k1a based on defect information regarding the first interconnects 30_11 to 30_k1. For example, the first repair circuit 115_1 may route the first data signals D_11a to D_k1a to replace at least one of the first interconnects 30_11 to 30_k1 determined to be defective with at least one of the redundancy interconnects 30_711 and 30_721. The first redundancy flip-flops 116_1 and 116_2 and the first redundancy transmission buffers 117_1 and 117_2 may form alternative data paths in the first semiconductor die 10.

In an embodiment, the second repair circuit 115_2 may route the first clock signal CLKaa based on defect information regarding the first interconnect 30_131. For example, the second repair circuit 115_2 may route the first clock signal CLKaa to replace the first interconnect 30_131, which is defective with the redundancy interconnect 30_181. The first redundancy transmission buffer 118 may form an alternative clock path in the first semiconductor die 10.

In an embodiment, the second interface circuit 200 of the second semiconductor die 20 may include the second unit circuit 210_1, and the second unit circuit 210_1 may include the second flip-flops 211_1 to 211_k, the first reception buffers 212_1 to 212_k and 213, a third repair circuit 215_1, a fourth repair circuit 215_2, second redundancy flip-flops 216_1 and 216_2, and first redundancy reception buffers 217_1, 217_2, and 218. For example, the second redundancy flip-flops 216_1 and 216_2 may replace some of the second flip-flops 211_1 to 211_k, and the first redundancy reception buffers 217_1, 217_2, and 218 may replace some of the first reception buffers 212_1 to 212_k and 213.

In an embodiment, the third repair circuit 215_1 may route the first data signals D_11b to D_k1b based on defect information regarding the first interconnects 30_11 to 30_k1. For example, the third repair circuit 215_1 may route the first data signals D_11b to D_k1b to replace at least one of the first interconnects 30_11 to 30_k1 determined to be defective with at least one of the redundancy interconnects 30_711 and 30_721. The second redundancy flip-flops 216_1 and 216_2 and the first redundancy reception buffers 217_1 and 217_2 may form alternative data paths in the second semiconductor die 20.

In an embodiment, the fourth repair circuit 215_2 may route the first clock signal CLKab based on defect information regarding the first interconnect 30_131. For example, the fourth repair circuit 215_2 may route the first clock signal CLKab to replace the first interconnect 30_131, which is defective, with the redundancy interconnect 30_181. The first redundancy reception buffer 218 may form an alternative clock path in the second semiconductor die 20.

In addition, in an embodiment, the components of the first unit circuit 110_1 and the components of the second unit circuit 210_1 may be arranged symmetrically with respect to each other. That is, in FIG. 8, the first repair circuit 115_1, the second repair circuit 115_2, the first redundancy flip-flops 116_1 and 116_2, and the first redundancy transmission buffers 117_1, 117_2, and 118 of the first unit circuit 110_1 may be arranged as symmetric counterparts, respectively, to the third repair circuit 215_1, the fourth repair circuit 215_2, the second redundancy flip-flops 216_1 and 216_2, and the first redundancy reception buffers 217_1, 217_2, and 218 of the second unit circuit 210_1.

However, the embodiment of the three-dimensional integrated circuit 1D of FIG. 8 is only an example, and embodiments of the present disclosure are not limited thereto.

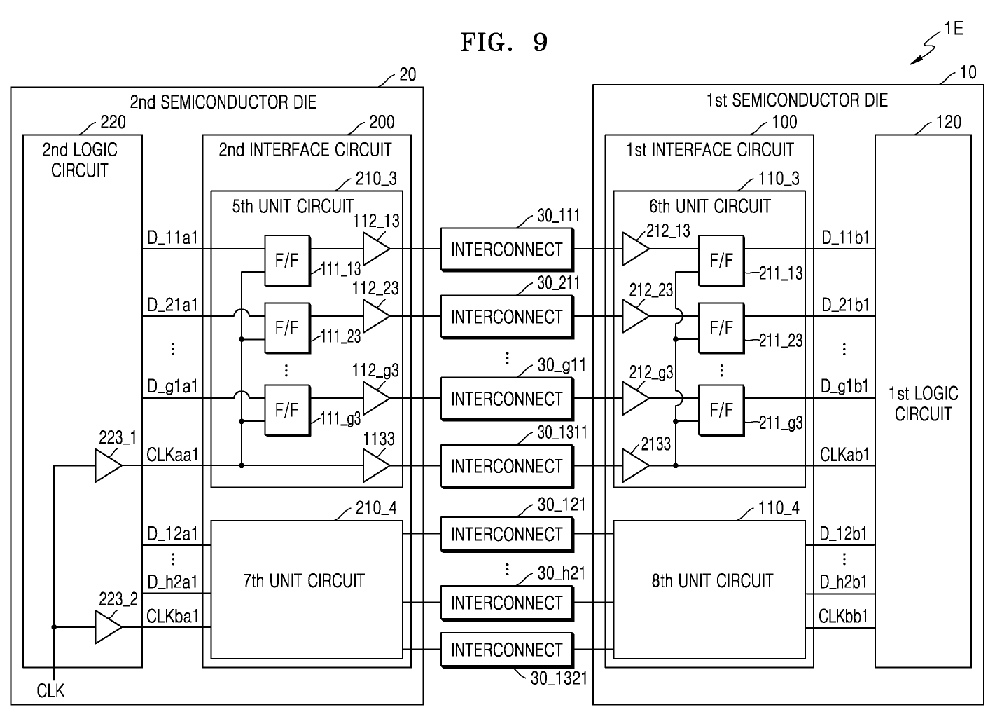

FIG. 9 is a detailed block diagram of a three-dimensional integrated circuit 1E according to an embodiment. Hereinafter, for convenience of explanation, a description that is substantially the same as a description given with reference to FIG. 5 may be omitted.

Referring to FIG. 9, the three-dimensional integrated circuit 1E may include the first semiconductor die 10, the second semiconductor die 20, third interconnects 30_111 to 30_g11 (e.g., third interconnects 30_111, 30_211, …, 30_g11) and 30_1311, and fourth interconnects 30_121 to 30_h21 and 30_1321.

The second semiconductor die 20 may include the second interface circuit 200 and the second logic circuit 220. The second interface circuit 200 may include a fifth unit circuit 210_3 and a seventh unit circuit 210_4.

The first semiconductor die 10 may include the first interface circuit 100 and the first logic circuit 120. The first interface circuit 100 may include a sixth unit circuit 110_3 and an eighth unit circuit 110_4.

For example, the fifth unit circuit 210_3 and the seventh unit circuit 210_4 may be referred to as unit transmission circuits, and the sixth unit circuit 110_3 and the eighth unit circuit 110_4 may be referred to as unit reception circuits.

In an embodiment, as the fifth unit circuit 210_3 may correspond to the sixth unit circuit 110_3, components of the fifth unit circuit 210_3 and components of the sixth unit circuit 110_3 may be arranged symmetrically with respect to each other.

In an embodiment, the fifth unit circuit 210_3 may transmit third data signals D_11a1 to D_g1a1 (e.g., third data signals D_11a1, D_21a1, …, D_g1a1) and a third clock signal CLKaa1 received from the second logic circuit 220 to the sixth unit circuit 110_3 through the third interconnects 30_111 to 30_g11, and 30_1311. The fifth unit circuit 210_3 may include third flip-flops 111_13 to 111_g3 (e.g., third flip-flops 111_13, 111_23, …, 111_g3) and second transmission buffers 112_13 to 112_g3 (e.g., second transmission buffers 112_13, 112_23, …, 112_g3) and 1133. The third flip-flops 111_13 to 111_g3 may output the received third data signals D_11a1 to D_g1a1 synchronized with the third clock signal CLKaa1 to the second transmission buffers 112_13 to 112_g3. The third clock signal CLKaa1, which may be output by a third clock buffer 223_1 of the second logic circuit 220, may be based on a global clock signal CLK’. The second transmission buffers 112_13 to 112_g3 may output the third data signals D_11a1 to D_g1a1 through the third interconnects 30_111 to 30_g11. In addition, the second transmission buffer 1133 may output the received third clock signal CLKaa1 through the third interconnect 30_1311.

In an embodiment, the sixth unit circuit 110_3 may transmit third data signals D_11b1 to D_g1b1 (e.g., third data signals D_11b1, D_21b1, …, D_g1b1) and a third clock signal CLKab1 received through the third interconnects 30_111 to 30_g11 and 30_1311 to the first logic circuit 120. The sixth unit circuit 110_3 may include fourth flip-flops 211_13 to 211_g3 (e.g., fourth flip-flops 211_13, 211_23, …, 211_g3) and second reception buffers 212_13 to 212_g3 (e.g., second reception buffers 212_13, 212_23, …, 212_g3) and 2133. The fourth flip-flops 211_13 to 211_g3 may output the third data signals D_11b1 to D_g1b1 synchronized with the third clock signal CLKab1 and received through the third interconnects 30_111 to 30_g11 to the first logic circuit 120. In addition, the second reception buffer 2133 may output the third clock signal CLKab1 received through the third interconnect 30_1311 to the first logic circuit 120.

In an embodiment, as the seventh unit circuit 210_4 may correspond to the eighth unit circuit 110_4, components of the seventh unit circuit 210_4 and components of the eighth unit circuit 110_4 may be arranged symmetrically with respect to each other.

In an embodiment, the seventh unit circuit 210_4 may transmit fourth data signals D_12a1 to D_h2a1 and a fourth clock signal CLKba1 received from the second logic circuit 220 to the eighth unit circuit 110_4 through the fourth interconnects 30_121 to 30_h21 and 30_1321. For example, the seventh unit circuit 210_4 may include a number of flip-flops and transmission buffers that is the same as or different from a number of flip-flops and transmission buffers of the fifth unit circuit 210_3. The fourth clock signal CLKba1, which may be output by a fourth clock buffer 223_2 of the second logic circuit 220, may be based on the global clock signal CLK’.

In an embodiment, the eighth unit circuit 110_4 may transmit fourth data signals D_12b1 to D_h2b1 and a fourth clock signal CLKbb1 received through the fourth interconnects 30_121 to 30_h21 and 30_1321 to the first logic circuit 120. For example, the eighth unit circuit 110_4 may include a number of flip-flops and reception buffers that is the same as or different from a number of flip-flops and reception buffers of the sixth unit circuit 110_3.

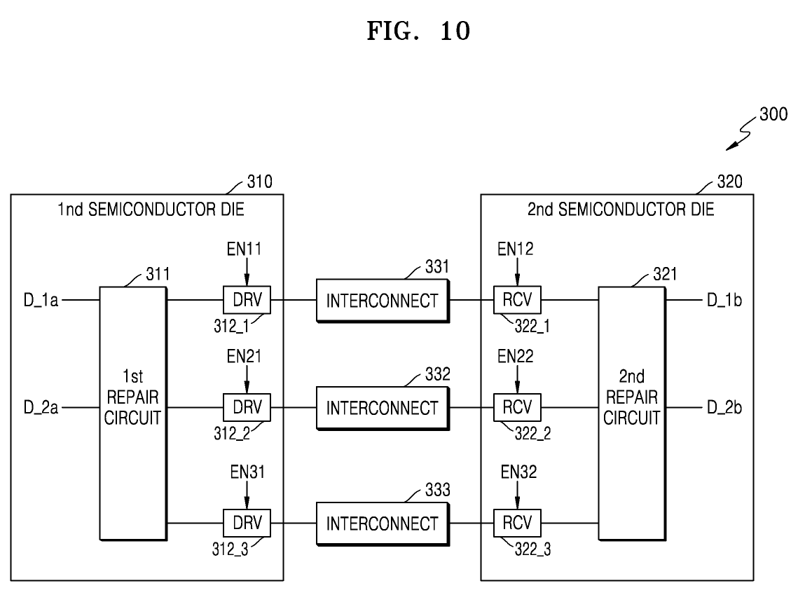

FIG. 10 is a detailed block diagram of a three-dimensional integrated circuit 300 according to an embodiment. Embodiments to be described with reference to FIGS. 10-15 may be applied to FIGS. 1-9. For example, a configuration of a transmission driving circuit or a configuration of a reception driving circuit to be described below may be applied to a configuration of the first transmission buffers 112_1 to 112_k and 113 or a configuration of the first reception buffers 212_1 to 212_k and 213 of FIG. 5.

Referring to FIG. 10, the three-dimensional integrated circuit 300 may include a first semiconductor die 310, a second semiconductor die 320, a first interconnect 331, a second interconnect 332, and a third interconnect 333.

In an embodiment, the first semiconductor die 310 may include a first repair circuit 311, a first transmission driving circuit 312_1, a second transmission driving circuit 312_2, and a third transmission driving circuit 312_3. The second semiconductor die 320 may include a second repair circuit 321, a first reception driving circuit 322_1, a second reception driving circuit 322_2, and a third reception driving circuit 322_3.

In an embodiment, the first repair circuit 311 may route a first data signal D_1a and a second data signal D_2a, based on defect information regarding any of the first to third interconnects 331, 332, and 333, to transmit the same to the second semiconductor die 320. That is, the first repair circuit 311 may route the first data signal D_1a and the second data signal D_2a to block the signal path including the defective interconnect based on the defect information. The second repair circuit 321 may route a first data signal D_1b and a second data signal D_2b, based on defect information regarding any of the first to third interconnects 331, 332, and 333, to transmit the same to a logic circuit of the second semiconductor die 320. That is, the second repair circuit 321 may route the first data signal D_1b and the second data signal D_2b to block the signal path including the defective interconnect based on the defect information.

In an embodiment, when the first interconnect 331 is normal, the first transmission driving circuit 312_1 may be enabled based on a first enable control signal EN11, to receive any one of the first data signal D_1a and the second data signal D_2a from the first repair circuit 311 and transmit the received data signal to the second semiconductor die 320 through the first interconnect 331. Additionally, when the first interconnect 331 is normal, the first reception driving circuit 322_1 may be enabled based on a second enable control signal EN12, to transmit the data signal received through the first interconnect 331 to the second repair circuit 321.

In an embodiment, when the first interconnect 331 is defective, the first transmission driving circuit 312_1 may be disabled based on the first enable control signal EN11, and the first reception driving circuit 322_1 may also be disabled based on the second enable control signal EN12. By disabling both the first transmission driving circuit 312_1 and the first reception driving circuit 322_1, the first interconnect 331, which is defective, may be completely isolated. As a result, the overcurrent or leakage current caused by the first interconnect 331, which is defective, may be prevented.

Similarly, depending on whether the second interconnect 332 is defective, the second transmission driving circuit 312_2 and the second reception driving circuit 322_2 may be controlled to be enabled or disabled by a third enable control signal EN21 and a fourth enable control signal EN22, respectively. In addition, depending on whether the third interconnect 333 is defective, the third transmission driving circuit 312_3 and third reception driving circuit 322_3 may be controlled to be enabled or disabled by a fifth enable control signal EN31 and a sixth enable control signal EN32, respectively.

The three-dimensional integrated circuit 300 of FIG. 10 is only an example, and embodiments of the present disclosure are not limited thereto. The three-dimensional integrated circuit 300 may include a greater number of semiconductor dies or interconnects, or each of the first semiconductor die 310 and the second semiconductor die 320 of the three-dimensional integrated circuit 300 may include a greater number of transmission driving circuits or reception driving circuits.

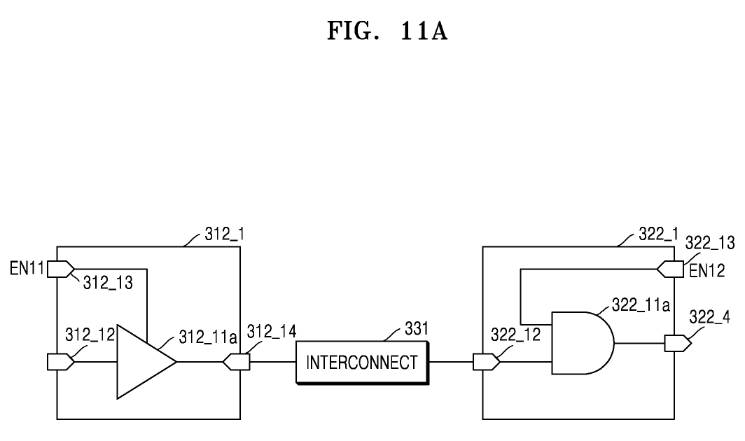

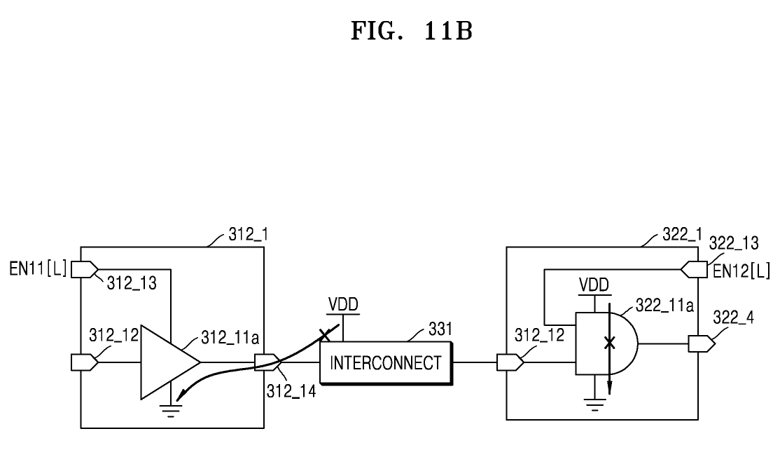

FIGS. 11A and 11B are diagrams illustrating one implementation of the first transmission driving circuit 312_1 and the first reception driving circuit 322_1 according to an embodiment.

Referring to FIG. 11A, the first transmission driving circuit 312_1 may be connected to the first reception driving circuit 322_1 through the first interconnect 331.

In an embodiment, the first transmission driving circuit 312_1 may include a first tri-state buffer 312_11a, a first data input terminal 312_12, a first control input terminal 312_13, and a first data output terminal 312_14.

In an embodiment, the first tri-state buffer 312_11a may be enabled or disabled by receiving the first enable control signal EN11 through the first control input terminal 312_13. For example, when the first tri-state buffer 312_11a is enabled based on the first enable control signal EN11 being at a high level, a data signal at a low level or a high level may be output through the first data output terminal 312_14, and when the first tri-state buffer 312_11a is disabled based on the first enable control signal EN11 being at a low level, the first data output terminal 312_14 may be in a high impedance (Hi-Z) state.

In an embodiment, the first reception driving circuit 322_1 may include a first logic gate buffer 322_11a, a second data input terminal 322_12, a third data input terminal 322_13, and a second data output terminal 322_4. For example, the first logic gate buffer 322_11a may be an AND gate buffer.

In an embodiment, the first logic gate buffer 322_11a may receive the second enable control signal EN12 through the third data input terminal 322_13 to control the output of the second data output terminal 322_4. For example, the first logic gate buffer 322_11a may output, through the second data output terminal 322_4, a signal corresponding to the level of the data signal received through the second data input terminal 322_12, based on the second enable control signal EN12 being at a high level. This may be defined as the first logic gate buffer 322_11a being enabled. In addition, based on the second enable control signal EN12 being at a low level, the first logic gate buffer 322_11a may fix the second data output terminal 322_4 to a low-level state regardless of the state of the second data input terminal 322_12. This may be defined as the first logic gate buffer 322_11a being disabled.

In some embodiments, the first logic gate buffer 322_11a may be implemented as an OR gate buffer, and the structure of the first reception driving circuit 322_1 may be modified for the OR gate buffer to perform the same or similar operations as the AND gate buffer.

Referring further to FIG. 11B, an example is described in which the first interconnect 331, which is defective, is isolated, according to an embodiment.

First, an example involving the first transmission driving circuit 312_1 and the first interconnect 331, which is defective, is described. As the first tri-state buffer 312_11a is disabled by the first enable control signal EN11 at a low level and the first data output terminal 312_14 is in a Hi-Z state, a current path from a power supply voltage VDD to ground of the first tri-state buffer 312_11a, which could otherwise be formed due to a defect of the first interconnect 331, may be blocked. In some embodiments, when the first interconnect 331 is connected to ground due to the defect of the first interconnect 331, a current path to ground that could be formed through the first interconnect 331 may be blocked by the first tri-state buffer 312_11a.

An example involving the first reception driving circuit 322_1 and the first interconnect 331, which is defective, is also described. When the second data input terminal 322_12 is disconnected from the first reception driving circuit 322_1 and floats due to the defect of the first interconnect 331, the leakage current that can occur from the power supply voltage VDD of the first reception driving circuit 322_1 to ground may be blocked by the first logic gate buffer 322_11a being disabled by the second enable control signal EN12 at a low level.

As a result, the first interconnect 331 which is defective, may be completely isolated.

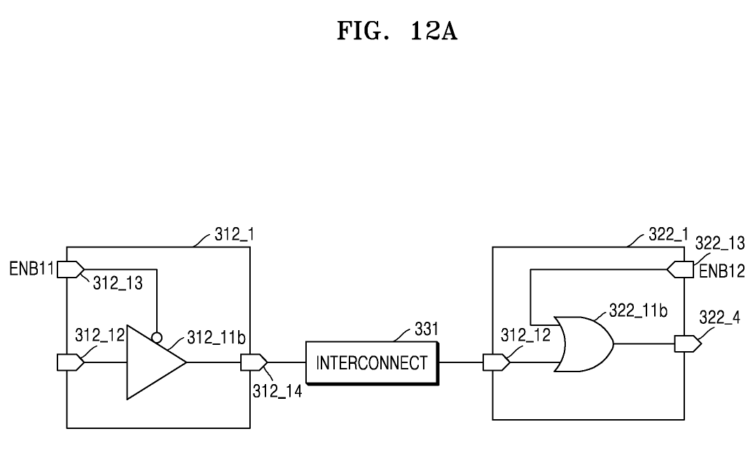

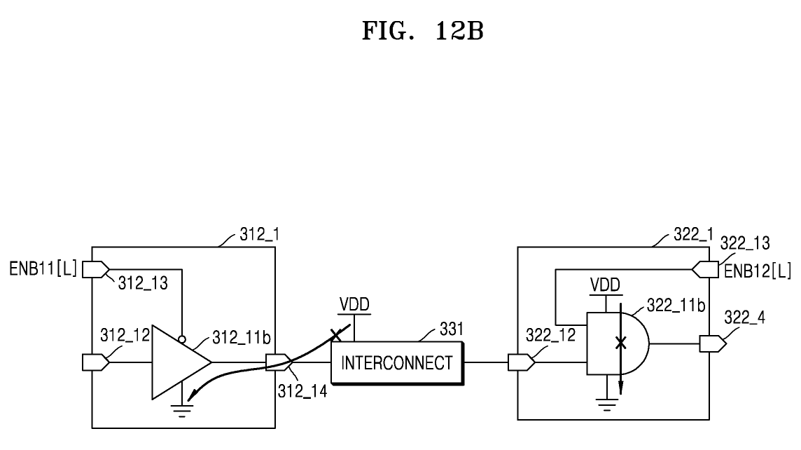

FIGS. 12A and 12B are diagrams illustrating another implementation of the first transmission driving circuit 312_1 and the first reception driving circuit 322_1 according to an embodiment.

Referring to FIG. 12A, the first transmission driving circuit 312_1 may be connected to the first reception driving circuit 322_1 through the first interconnect 331.

In an embodiment, the first transmission driving circuit 312_1 may include a first tri-state buffer 312_11b, the first data input terminal 312_12, the first control input terminal 312_13, and the first data output terminal 312_14.

In an embodiment, the first tri-state buffer 312_11b may be enabled or disabled by receiving a first inverted enable control signal ENB11 through the first control input terminal 312_13. For example, when the first tri-state buffer 312_11b is enabled based on the first inverted enable control signal ENB11 being at a low level, a low-level or high-level data signal may be output through the first data output terminal 312_14, and when the first tri-state buffer 312_11b is disabled based on the first inverted enable control signal ENB11 being at a high level, the first data output terminal 312_14 may be in a Hi-Z state.

In an embodiment, the first reception driving circuit 322_1 may include a first logic gate buffer 322_11b, the second data input terminal 322_12, the third data input terminal 322_13, and the second data output terminal 322_4. For example, the first logic gate buffer 322_11b may be an OR gate buffer.

In an embodiment, the first logic gate buffer 322_11b may receive a second inverted enable control signal ENB12 through the third data input terminal 322_13 to control the output of the second data output terminal 322_4. For example, the first logic gate buffer 322_11b may output, through the second data output terminal 322_4, a signal corresponding to the level of the data signal received through the second data input terminal 322_12, based on the second inverted enable control signal ENB12 being at a low level. This may be defined as the first logic gate buffer 322_11b being enabled. In addition, based on the second inverted enable control signal ENB12 being at a high level, the first logic gate buffer 322_11b may fix the second data output terminal 322_4 to a high-level state regardless of the state of the second data input terminal 322_12. This may be defined as the first logic gate buffer 322_11b being disabled.

In some embodiments, the first logic gate buffer 322_11b may be implemented as an AND gate buffer, and the structure of the first reception driving circuit 322_1 may be modified for the AND gate buffer to perform the same or similar operations as the OR gate buffer.

Referring further to FIG. 12B, an example is described in which the first interconnect 331, which is defective, is isolated according to an embodiment.

First, an example involving the first transmission driving circuit 312_1 and the first interconnect 331, which is defective, is described. As the first tri-state buffer 312_11b is disabled by the first inverted enable control signal ENB11 at a high level and the first data output terminal 312_14 is in a Hi-Z state, the current path from the power supply voltage VDD to ground of the first tri-state buffer 312_11b, which could otherwise be formed due to the defect of the first interconnect 331, may be blocked. In some embodiments, when the first interconnect 331 is connected to ground due to the defect of the first interconnect 331, the current path to ground that could be formed through the first interconnect 331 may be blocked by the first tri-state buffer 312_11b.

An example involving the first reception driving circuit 322_1 and the first interconnect 331, which is defective, is also described. When the second data input terminal 322_12 is disconnected from the first reception driving circuit 322_1 and floats due to the defect of the first interconnect 331, the leakage current that can occur from the power supply voltage VDD of the first reception driving circuit 322_1 to ground may be blocked by the first logic gate buffer 322_11b being disabled by the second inverted enable control signal ENB12 at a low level.

As a result, the first interconnect 331, which is defective, may be completely isolated.

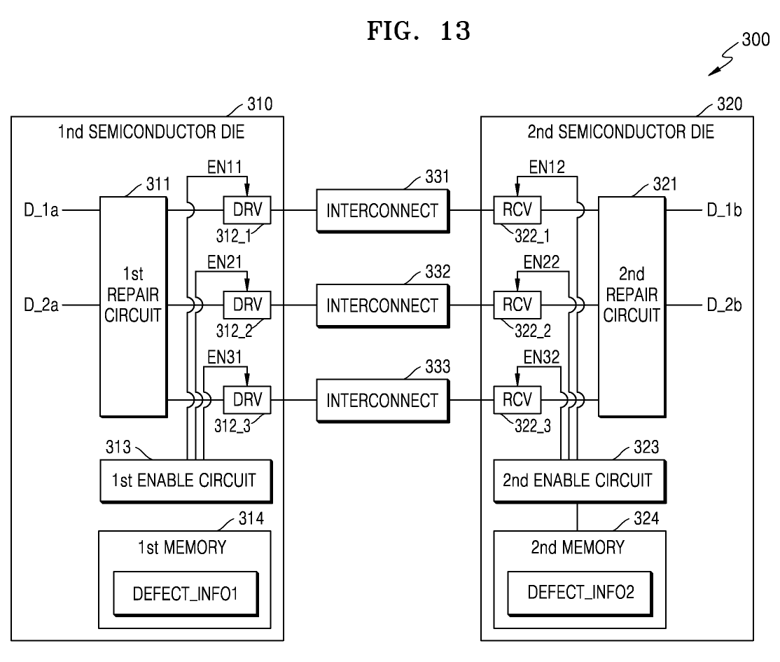

FIG. 13 is a detailed block diagram of a three-dimensional integrated circuit 300 according to an embodiment. Hereinafter, for convenience of explanation, a description that is substantially the same as a description given with reference to FIG. 10 may be omitted.

Referring to FIG. 13, the three-dimensional integrated circuit 300 may include the first semiconductor die 310, the second semiconductor die 320, and the first to third interconnects 331, 332, and 333.

In an embodiment, the first semiconductor die 310 may further include a first enable circuit 313 and a first memory 314, compared to the embodiment of FIG. 10. The first enable circuit 313 may generate the first, third, and fifth enable control signals EN11, EN21, and EN31, based on first defect information DEFECT_INFO1 stored in the first memory 314 for the first to third interconnects 331, 332, and 333, and provide the same to the first to third transmission driving circuits 312_1, 312_2, and 312_3, respectively. In some embodiments, the first defect information DEFECT_INFO1 may include information that directly or indirectly indicates a transmission driving circuit to be enabled and a transmission driving circuit to be disabled.

In an embodiment, the second semiconductor die 320 may further include a second enable circuit 323 and a second memory 324, compared to the embodiment of FIG. 10. The second enable circuit 323 may generate the second, fourth, and sixth enable control signals EN12, EN22, and EN32, based on second defect information DEFECT_INFO2 stored in the second memory 324 for the first to third interconnects 331, 332, and 333, and provide the same to the first to third reception driving circuits 322_1, 322_2, and 322_3, respectively. In some embodiments, the second defect information DEFECT_INFO2 may include information that directly or indirectly indicates a reception driving circuit to be enabled and a reception driving circuit to be disabled.

In an embodiment, the first memory 314 and the second memory 324 may be implemented as non-volatile memory. For example, the non-volatile memory may be implemented as read only memory (ROM), programmable ROM (PROM), erasable PROM (EPROM), electrically erasable PROM (EEPROM), flash memory, NAND flash memory, NOR flash memory, magnetoresistive RAM (MRAM), resistive RAM (ReRAM), or ferroelectric RAM (FRAM).

In addition, in some embodiments, the three-dimensional integrated circuit 300 may further include a first non-volatile memory arranged outside the first semiconductor die 310 and connected to the first semiconductor die 310, and a second non-volatile memory arranged outside the second semiconductor die 320 and connected to the second semiconductor die 320. For example, the first non-volatile memory may store the first defect information DEFECT_INFO1, and the second non-volatile memory may store the second defect information DEFECT_INFO2. When a chip including the three-dimensional integrated circuit 300 is powered on, the first semiconductor die 310 may read first defect information DEFECT_INFO1 from the first non-volatile memory and store the same in the first memory 314, and the second semiconductor die 320 may read the second defect information DEFECT_INFO2 from the second non-volatile memory and store the same in the second memory 324. The first non-volatile memory and the second non-volatile memory may be integrated into a single non-volatile memory.

In some embodiments, the first memory 314 may be arranged outside the first semiconductor die 310, and the second memory 324 may be arranged outside the second semiconductor die 320.

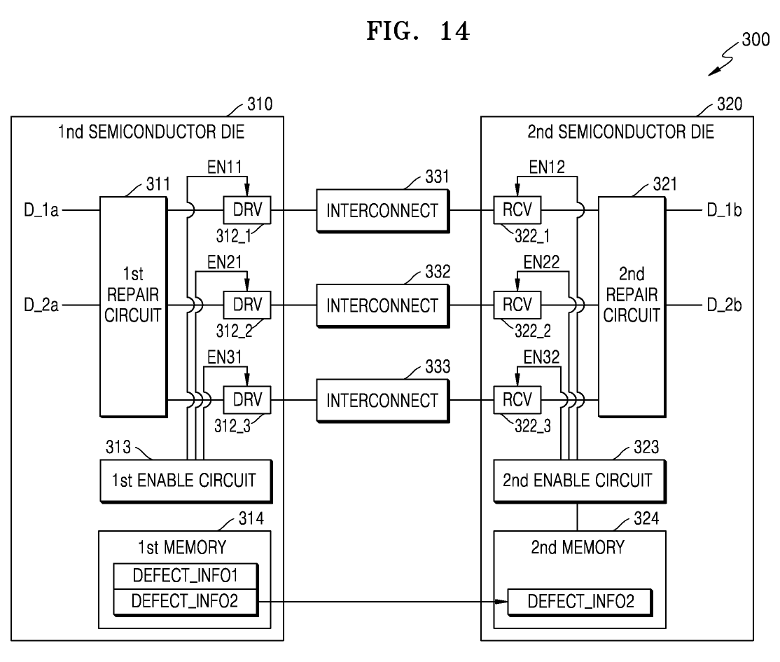

FIG. 14 is a detailed block diagram of a three-dimensional integrated circuit 300 according to an embodiment. Hereinafter, for convenience of explanation, a description that is substantially the same as a description given with reference to FIG. 13 may be omitted.

Referring to FIG. 14, the three-dimensional integrated circuit 300 may include the first semiconductor die 310, the second semiconductor die 320, and the first to third interconnects 331, 332, and 333.

In one embodiment, unlike the embodiment of FIG. 13, the second memory 324 may be implemented as volatile memory. For example, the volatile memory may be implemented as static RAM (SRAM), dynamic RAM (DRAM), synchronous RAM (SDRAM), or double data rate (DDR) SDRAM.

The second defect information DEFECT_INFO2 stored in the second memory 324 may be deleted when the chip including the three-dimensional integrated circuit 300 is powered off. Accordingly, the second defect information DEFECT_INFO2 may be further stored in the first memory 314, which may be non-volatile memory.

In an embodiment, when the chip is powered on, the second semiconductor die 320 may receive the second defect information DEFECT_INFO2 from the first semiconductor die 310 and store the same in the second memory 324.

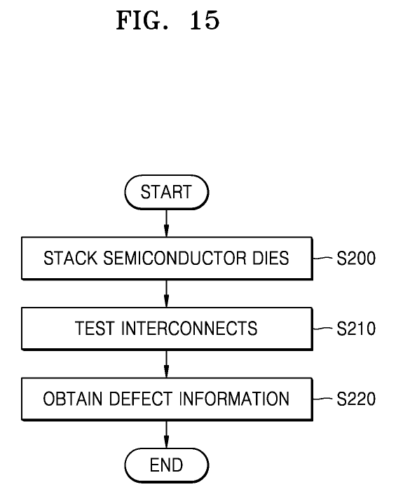

FIG. 15 is a flowchart of a method of obtaining defect information regarding interconnects, according to an embodiment.

Referring to FIG. 15, defect information regarding interconnects included in the three-dimensional integrated circuit may be generated at a mass production stage of the three-dimensional integrated circuit. The mass production stage may include operations S200 to S220.

In the operation S200, semiconductor dies included in the three-dimensional integrated circuit may be stacked.

In the operation S210, a test may be performed on the interconnects connecting the semiconductor dies.

In addition, in the operation S220, the defect information regarding the interconnects may be obtained. The obtained defect information may be stored in at least one memory of the semiconductor dies.

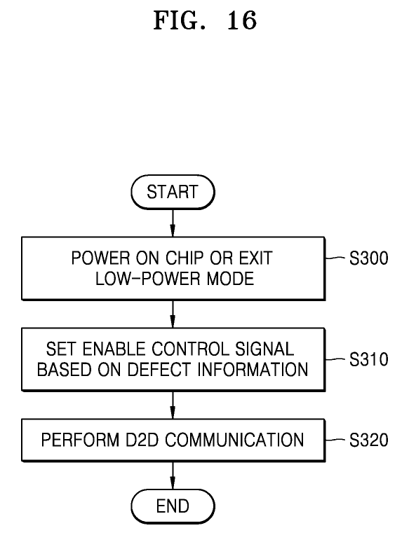

FIG. 16 is a flowchart of an operating method of the three-dimensional integrated circuit according to an embodiment.

Referring to FIG. 16, in an operation S300, the chip including the three-dimensional integrated circuit may be powered on or may exit a low-power mode.

In an operation S310, the enable circuit included in each of the semiconductor dies of the three-dimensional integrated circuit may set enable control signals based on the defect information.

In addition, in the operation S320, the semiconductor dies of the three-dimensional integrated circuit may perform die-to-die (D2D) communication based on the set enable control signals.

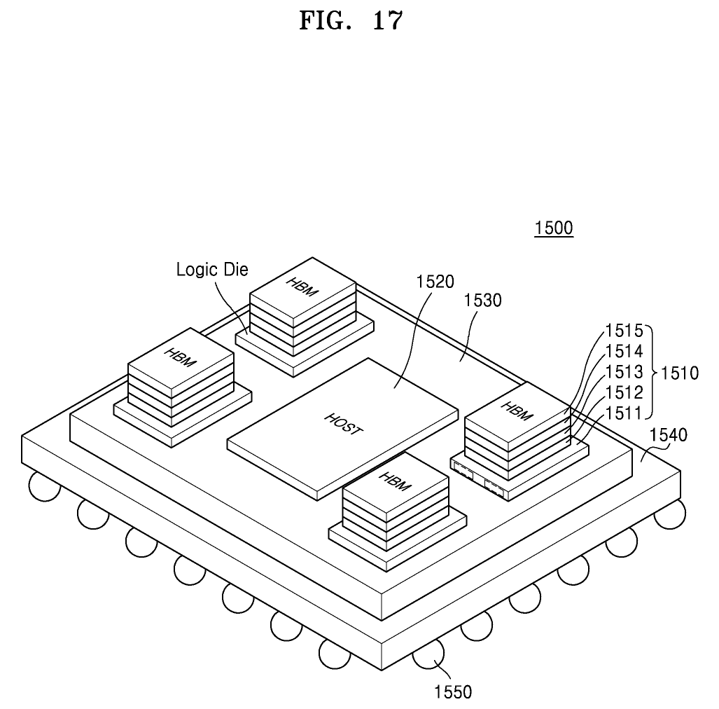

FIG. 17 is a structural diagram of an example of an electronic system 1500 including high-bandwidth memories (HBM) 1510 according to an embodiment.

Referring to FIG. 17, the electronic system 1500 may include the HBMs 1510 and a host 1520. The HBM 1510 may be the three-dimensional integrated circuit according to the aforementioned embodiments. The HBM 1510 may include a plurality of semiconductor dies 1511 to 1515 (e.g., semiconductor dies 1511, 1512, 1513, 1514, and 1514), and the plurality of semiconductor dies 1511 to 1515 may be electrically connected to each other through a plurality of interconnects. According to embodiments, the interface circuit included in each of the plurality of semiconductor dies 1511 to 1515 may be configured to perform static timing analysis at the design stage, and the interface circuit may include a driving circuit for completely isolating a defective interconnect.

The HBMs 1510 and the host 1520 may be mounted on an interposer 1530, and the interposer 1530 on which the HBMs 1510 and the host 1520 are mounted may be mounted on a package substrate 1540. Conductive means, such as solder balls 1550, may be mounted on the bottom of the package substrate 1540. The host 1520 may be various semiconductor devices that request memory access.

The interposer 1530 may be implemented in various forms, including TSV, organic printed circuit board (PCB), or non-TSV embedded multi-die interconnect bridge (EMIB).

In some embodiments, the host 1520 may also be implemented as the three-dimensional integrated circuit, wherein the host 1520 may include a plurality of stacked semiconductor dies, and the plurality of semiconductor dies may be electrically interconnected through the plurality of interconnects. According to embodiments, the interface circuit included in each of the semiconductor dies of the host 1520 may be configured to efficiently perform static timing analysis at the design stage, and the interface circuit may include a driving circuit for completely isolating a defective interconnect.

According to some embodiments of the present disclosure, a three-dimensional integrated circuit may include: a first semiconductor die including: a first logic circuit configured to perform a first data processing operation; and a first interface circuit including a first unit circuit; a second semiconductor die including: a second logic circuit configured to perform a second data processing operation; and a second interface circuit including a second unit circuit; and a plurality of interconnects configured to connect the first unit circuit to the second unit circuit, wherein the first unit circuit includes a plurality of first flip-flops and a plurality of transmission buffers, the plurality of first flip-flops and the plurality of transmission buffers configured to transmit a plurality of first data signals and a first clock signal through the plurality of interconnects, wherein the second unit circuit includes a plurality of second flip-flops and a plurality of reception buffers, the plurality of second flip-flops and the plurality of reception buffers configured to receive the plurality of first data signals and the first clock signal through the plurality of interconnects, and wherein components of the first unit circuit are arranged symmetrically with respect to components of the second unit circuit.

According to some embodiments of the present disclosure, a three-dimensional integrated circuit may include: a first semiconductor die including a first transmission driving circuit; a second semiconductor die including a first reception driving circuit; and a first interconnect configured to connect the first transmission driving circuit to the first reception driving circuit, wherein the first transmission driving circuit includes a first tri-state buffer configured to receive a first enable control signal through a control input terminal, and the first reception driving circuit includes a first logic gate buffer configured to receive a second enable control signal through a data input terminal.

While non-limiting example embodiments of the present disclosure have been described above with reference to the accompanying drawings, it will be understood that various changes in form and details may be made thereon without departing from the spirit and scope of the present disclosure.

What is claimed is:

1. A method performed by at least one processor, the method comprising:
designing a three-dimensional integrated circuit, the three-dimensional integrated circuit including:
a first semiconductor die including a first logic circuit and a first interface circuit;
a second semiconductor die including a second logic circuit and a second interface circuit; and
a plurality of interconnects configured to connect the first interface circuit to the second interface circuit; and
performing static timing analysis (STA) individually for a first STA target group, a second STA target group, and a third STA target group of the three-dimensional integrated circuit,
wherein the first logic circuit and a first portion of the first interface circuit are included in the first STA target group,
wherein the second logic circuit and a first portion of the second interface circuit are included in the second STA target group, and
wherein a second portion of the first interface circuit, the plurality of interconnects, and a second portion of the second interface circuit are included in the third STA target group.

2. The method of claim 1, wherein the performing comprises:
performing the static timing analysis for the first STA target group based on a first process condition of the first semiconductor die;
performing the static timing analysis for the second STA target group based on a second process condition of the second semiconductor die; and
performing the static timing analysis for the third STA target group based on the first process condition and the second process condition.

3. The method of claim 1, wherein the performing comprises performing the static timing analysis for the third STA target group after the static timing analysis for the first STA target group and the static timing analysis for the second STA target group are completed.

4. The method of claim 1, wherein the first interface circuit includes a first unit circuit, and the first unit circuit includes:
a plurality of first flip-flops configured to output a plurality of first data signals, which are received by the plurality of first flip-flops from the first logic circuit and are synchronized with a first clock signal received from the first logic circuit; and
a plurality of first transmission buffers configured to output the first clock signal and the plurality of first data signals through first interconnects among the plurality of interconnects.

5. The method of claim 4, wherein the first portion of the first interface circuit includes the plurality of first flip-flops, and the second portion of the first interface circuit includes the plurality of first flip-flops and the plurality of first transmission buffers.

6. The method of claim 4, wherein the second interface circuit includes a second unit circuit, and the second unit circuit includes:
a plurality of first reception buffers configured to receive, through the first interconnects, the plurality of first data signals and the first clock signal; and
a plurality of second flip-flops configured to output, to the second logic circuit, the plurality of first data signals, which are received from some of the plurality of first reception buffers and synchronized with the first clock signal received from another one of the plurality of first reception buffers.

7. The method of claim 6, wherein the second portion of the first interface circuit includes the plurality of first flip-flops and the plurality of first transmission buffers, and the second portion of the second interface circuit includes the plurality of first reception buffers and the plurality of second flip-flops.

8. The method of claim 6, wherein lengths of first data paths from the first logic circuit to the plurality of first flip-flops in the first semiconductor die differ from lengths of second data paths from the plurality of second flip-flops to the second logic circuit in the second semiconductor die by less than a predetermined first threshold.

9. The method of claim 7, wherein lengths of third data paths from the plurality of first transmission buffers to first points of the first interconnects in the first semiconductor die differ from lengths of fourth data paths from second points of the first interconnects to the plurality of first reception buffers in the second semiconductor die by less than a predetermined second threshold.

10. The method of claim 6, wherein the first unit circuit further includes a first delay buffer configured to delay the first clock signal received from the plurality of first flip-flops, and
wherein the second unit circuit further includes a plurality of second delay buffers configured to delay the plurality of first data signals received from the plurality of second flip-flops.

11. The method of claim 6, wherein a first edge of the first clock signal for operating the plurality of first flip-flops is different from a second edge of the first clock signal for operating the plurality of second flip-flops.

12. The method of claim 4, wherein the first unit circuit further includes:
at least one first redundancy flip-flop configured to replace at least one of the plurality of first flip-flops;
at least one first redundancy transmission buffer configured to receive an output of the at least one first redundancy flip-flop;
a second redundancy transmission buffer configured to replace a first transmission buffer, among the plurality of first transmission buffers, the first transmission buffer being configured to output the first clock signal;
a first repair circuit configured to route the plurality of first data signals based on defect information regarding the first interconnects; and
a second repair circuit configured to route the first clock signal based on the defect information.

13. The method of claim 4, wherein the first interface circuit further includes a third unit circuit, and the third unit circuit includes:
a plurality of third flip-flops configured to output a plurality of second data signals, which are synchronized with a second clock signal received from the first logic circuit and are received from the second logic circuit; and
a plurality of second transmission buffers configured to output the second clock signal and the plurality of second data signals output from the plurality of third flip-flops through second interconnects among the plurality of interconnects.

14. The method of claim 13, wherein the second interface circuit includes a fourth unit circuit, and the fourth unit circuit includes:
a plurality of second reception buffers configured to receive the plurality of second data signals and the second clock signal through the second interconnects; and
a plurality of fourth flip-flops configured to output, to the second logic circuit, the plurality of second data signals, which are received from some of the plurality of second reception buffers and are synchronized with the second clock signal received from another one of the plurality of second reception buffers.

15. The method of claim 13, wherein a number of the plurality of first flip-flops of the first unit circuit is different from a number of the plurality of third flip-flops of the third unit circuit, and a number of the plurality of first transmission buffers, of the first unit circuit, configured to output the first clock signal is identical to a number of a plurality of third transmission buffers, of the third unit circuit, configured to output the second clock signal.

16. The method of claim 1, wherein the first interface circuit includes a transmission driving circuit configured to output a data signal or a clock signal through a first interconnect among the plurality of interconnects,
wherein the second interface circuit includes a reception driving circuit configured to receive the data signal or the clock signal through the first interconnect,
wherein the transmission driving circuit includes a tri-state buffer configured to receive a first enable control signal through a control input terminal, and
wherein the reception driving circuit includes a logic gate buffer configured to receive a second enable control signal through a data input terminal.

17. The method of claim 16, wherein the logic gate buffer includes an AND gate buffer or an OR gate buffer.

18. A three-dimensional integrated circuit comprising:
a first semiconductor die comprising a first logic circuit configured to perform a first data processing operation and a first interface circuit comprising a first unit circuit;
a second semiconductor die comprising a second logic circuit configured to perform a second data processing operation and a second interface circuit comprising a second unit circuit; and
a plurality of interconnects configured to connect the first unit circuit to the second unit circuit,
wherein the first unit circuit comprises a plurality of first flip-flops and a plurality of transmission buffers configured to transmit a plurality of first data signals and a first clock signal through the plurality of interconnects,
wherein the second unit circuit comprises a plurality of second flip-flops and a plurality of reception buffers configured to receive the plurality of first data signals and the first clock signal through the plurality of interconnects, and
wherein components of the first unit circuit and components of the second unit circuit are arranged symmetrically.

19. The three-dimensional integrated circuit of claim 18, wherein the first logic circuit and a first portion of the first unit circuit are included in a first static timing analysis (STA) target group at a design stage,
the second logic circuit and a first portion of the second unit circuit are included in a second STA target group at the design stage,
a second portion of the first unit circuit, the plurality of interconnects, and a second portion of the second unit circuit are included in a third STA target group at the design stage, and
static timing analysis is performed individually for the first to third STA target groups at the design stage.

20. A method performed by at least one processor, the method comprising:
designing a three-dimensional integrated circuit, the three-dimensional integrated circuit including:
a first semiconductor die including a first interface circuit including a plurality of first unit circuits;
a second semiconductor die including a second interface circuit including a plurality of second unit circuits; and
a plurality of interconnects configured to connect the first interface circuit to the second interface circuit; and
performing static timing analysis (STA), based on process conditions of the first semiconductor die and the second semiconductor die, for at least one STA target group of the three-dimensional integrated circuit,
wherein each of the plurality of first unit circuits is configured to output a clock signal and a plurality of data signals through some of the plurality of interconnects,
wherein each of the plurality of second unit circuits is configured to receive the clock signal and the plurality of data signals through some of the plurality of interconnects, and
wherein the plurality of first unit circuits, the plurality of second unit circuits, and the plurality of interconnects are included in the at least one STA target group.
